(19) United States
(12) Patent Application Publication
(10) Pub. No.: US 2024/0297416 A1
(43) Pub. Date: Sep. 5, 2024

(54) BATTERY CELL

(71) Applicant: SK ON CO., LTD., Seoul (KR)

(72) Inventor: Yea Eun KIM, Daejeon (KR)

(21) Appl. No.: 18/433,423

(22) Filed: Feb. 6, 2024

(30) Foreign Application Priority Data
Mar. 2, 2023 (KR) 10-2023-0027694

(51) Int. Cl. H01M 50/531; H01M 50/105; H01M 50/186

(52) U.S. Cl. CPC H01M 50/531; H01M 50/105; H01M 50/186

(57) ABSTRACT

A battery cell is disclosed. In an embodiment, the battery cell comprises an electrode assembly, a pouch unit that is sealed and includes a pouch sheet configured to form an inner face and an outer face and an accommodation portion that is formed on the inner face of the pouch sheet, accommodates the electrode assembly, and is concave on the inner face of the pouch sheet, an electrode tab configured to extend from the electrode assembly, pass through the pouch unit, and protrude from the pouch unit, and a guard including a guard body coupled to the electrode tab and a guard wing configured to bend and extend from the guard body and be accommodated in the accommodation portion.

### CROSS-REFERENCE TO RELATED APPLICATIONS

This patent document claims the priority and benefits of Korean Patent Application No. 10-2023-0027694 filed on Mar. 2, 2023, which is incorporated herein by reference in its entirety.

### TECHNICAL FIELD

The technology and implementations disclosed in this patent document generally relate to a battery cell. In particular, the disclosed technology relates to a battery cell effectively maintaining a connection of an electrode tab and an electrode assembly.

### BACKGROUND

In a secondary battery, an electrode tab is connected to an electrode assembly. The electrode tab includes a plurality of electrode foils extending from the electrode assembly. When an external force acts in a direction in which the electrode tab is separated from the electrode assembly, tension may be formed in the plurality of electrode foils. If the tension above a certain level is formed in the electrode foils, the electrode foils may break.

If the electrode foils break, the total capacity of the secondary battery may decrease. Therefore, even if the tension is applied to the electrode tab, it is necessary to prevent a movement of the electrode tab relative to the electrode assembly.

### SUMMARY

The disclosed technology can be implemented in some embodiments to address the above-described and other problems.

In addition, the disclosed technology can be implemented in some embodiments to provide a battery cell preventing a disconnection of an electrode tab.

In order to achieve the above-described and other objects, in one aspect of the disclosed technology, a battery cell may comprise an electrode assembly; a pouch unit being sealed, the pouch unit including a pouch sheet configured to form an inner face and an outer face, and an accommodation portion formed on the inner face of the pouch sheet, the accommodation portion accommodating the electrode assembly, the accommodation portion being concave on the inner face of the pouch sheet; an electrode tab configured to extend from the electrode assembly, pass through the pouch unit, and protrude from the pouch unit; and a guard including a guard body coupled to the electrode tab, and a guard wing configured to bend and extend from the guard body and be accommodated in the accommodation portion.

The pouch unit may further include a pouch sealing portion that is formed along a perimeter of the pouch sheet and is connected to the accommodation portion. The accommodation portion may include a wall connected to the pouch sealing portion and a bottom configured to bend and extend from the wall, and the wall may extend from a perimeter of the bottom.

The guard wing may face the wall.

The electrode tab may include a plurality of electrode foils configured to extend from the electrode assembly toward the guard body, and an electrode tab body configured to extend from the plurality of electrode foils and coupled to the guard body.

The guard wing may be positioned between the wall and the plurality of electrode foils.

The guard wing may include a guard wing outer surface configured to face the wall, and a guard wing inner surface configured to face the plurality of electrode foils.

A length of the guard wing may be greater than a length of the guard body, with reference to a width direction of the battery cell.

When the electrode tab moves in a direction in which the electrode tab is separated from the electrode assembly, the accommodation portion may prevent a movement of the guard wing.

A length of the guard wing may correspond to a length of the accommodation portion, with reference to a thickness direction of the battery cell.

The guard wing and the guard body may be formed integrally.

The accommodation portion may include a first accommodation portion and a second accommodation portion that are formed on the inner face of the pouch sheet and are spaced apart from each other. The first accommodation and the second accommodation may be concave on the inner face of the pouch sheet. The pouch unit may further include a connection portion positioned between the first accommodation portion and the second accommodation portion, and the connection portion may connect the first accommodation portion and the second accommodation portion.

The guard may include a first guard and a second guard. At least a part of the first guard may be accommodated in the first accommodation portion, and at least a part of the second guard may be accommodated in the second accommodation portion.

Each of the first guard and the second guard may include the guard body and the guard wing. The guard body of the first guard and the guard body of the second guard may be spaced apart from each other and face each other.

A direction in which the guard wing of the first guard extends from the guard body of the first guard may be opposite to a direction in which the guard wing of the second guard extends from the guard body of the second guard.

A length of the guard wing may be a length of the guard body, with reference to a width direction of the battery cell.

The guard wing may include a guard wing plate configured to form both faces, and a guard wing opening formed in the guard wing plate.

The guard wing plate may include a guard wing inner surface configured to face the electrode assembly, and a guard wing outer surface formed opposite the guard wing inner surface.

The guard body may include a first guard body extending from a side of the guard wing opening, and a second guard body extending from another side of the guard wing opening.

The electrode tab may be positioned between the first guard body and the second guard body.

The first guard body and the second guard body may be spaced apart from each other and face each other.

According to at least one of embodiments of the disclosed technology, a battery cell suppressing a disconnection of an electrode tab can be provided.

A battery cell based on some embodiments of the disclosed technology can be widely applied in green technology fields such as electric vehicles, battery charging stations, and other battery-based solar power generation and wind power generation.

A battery cell based on some embodiments of the disclosed technology can be used in eco-friendly electric vehicles, hybrid vehicles, etc. to prevent climate change by suppressing air pollution and greenhouse gas emissions.

### BRIEF DESCRIPTION OF THE DRAWINGS

The accompanying drawings illustrate examples of embodiments of various technical features disclosed in the disclosure.

FIG. 1 is a perspective view of a battery cell based on an embodiment of the disclosed technology.

FIG. 2 is an exploded perspective view of a battery cell based on an embodiment of the disclosed technology.

FIG. 3 is a cross-sectional view of a pouch unit taken along B1-B2 of FIG. 2.

FIG. 4 is a cross-sectional view of a pouch sheet taken along C1-C2 of FIG. 2.

FIG. 5 is a cross-sectional view of a battery cell taken along A1-A2 of FIG. 1.

FIG. 6 is a perspective view of a guard based on an embodiment of the disclosed technology.

FIG. 7 is an exploded perspective view of a guard.

FIG. 8 illustrates a guard formed in one plane.

FIG. 9 is a cross-sectional view of a guard taken along D1-D2 of FIG. 6.

FIG. 10 is a cross-sectional view of a battery cell taken along A1-A2 of FIG. 1 when the battery cell illustrated in FIG. 1 includes a guard.

FIG. 11 illustrates a guard in which a length of a guard wing connection edge is the same as a length of a guard body connection edge.

FIG. 12 illustrates a guard in which a guard wing of a first guard and a guard wing of a second guard are connected to form one body.

FIG. 13 illustrates a guard wing illustrated in FIG. 12.

### DETAILED DESCRIPTION

Reference will now be made in detail to embodiments of the disclosed technology, examples of which are illustrated in the accompanying drawings. However, the following description is merely an example and does not intended to limit the disclosed technology to a specific implementation.

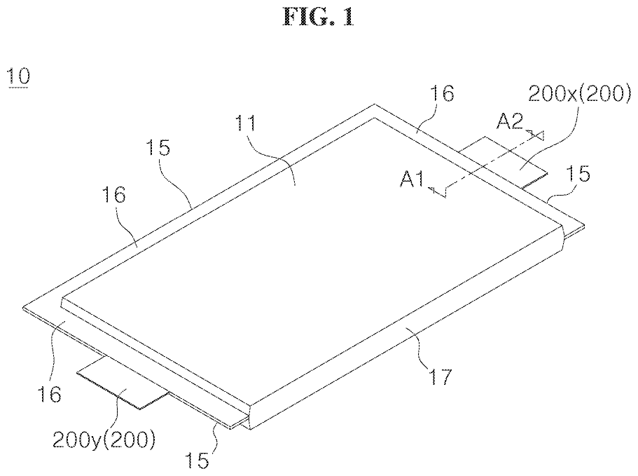

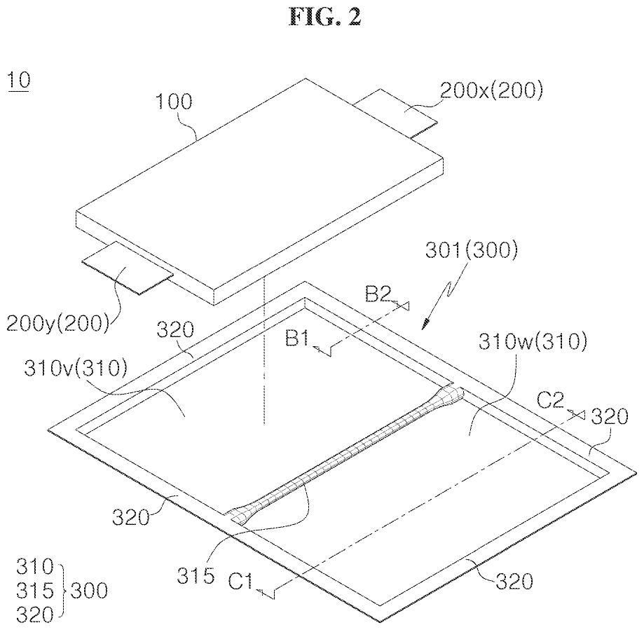

FIG. 1 is a perspective view of a battery cell based on an embodiment of the disclosed technology. FIG. 2 is an exploded perspective view of a battery cell based on an embodiment of the disclosed technology. FIG. 3 is a cross-sectional view of a pouch unit taken along B1-B2 of FIG. 2.

Referring to FIGS. 1 to 3, a battery cell 10 may include an electrode assembly 100. The battery cell 10 may include a pouch unit 300 accommodating the electrode assembly 100. The electrode assembly 100 may be surrounded by the pouch unit 300.

The electrode assembly 100 may be charged. When the electrode assembly 100 is charged, an electrical energy of the electrode assembly 100 may increase. The electrode assembly 100 may be discharged. When the electrode assembly 100 is discharged, the electrical energy of the electrode assembly 100 may decrease. The electrode assembly 100 may be referred to as a “jelly roll.”

The electrode assembly 100 may form a roughly hexahedral shape. The electrode assembly 100 may form a flat shape. For example, the electrode assembly 100 may form a flat hexahedron shape. For example, the electrode assembly 100 may form a shape that extends from one end and leads to another end.

The battery cell 10 may include a battery cell body 11. The battery cell body 11 may include the electrode assembly 100. The battery cell body 11 may include a portion of the pouch unit 300 that surrounds the electrode assembly 100. For example, it may include or indicate at least one of a portion of the pouch unit 300 surrounding the electrode assembly 100 and the electrode assembly 100.

The battery cell 10 may include an electrode tab 200. A plurality of electrode tabs 200 may be provided. For example, the electrode tab 200 may include a first electrode tab 200x and a second electrode tab 200y. The electrode tab 200 may be formed of a material containing metal. A longitudinal direction of the battery cell 10 may be parallel to a direction from the first electrode tab 200x to the second electrode tab 200y.

The electrode tab 200 may be connected to the electrode assembly 100. The first electrode tab 200x may be connected to one end of the electrode assembly 100. The first electrode tab 200x may be positioned at one end of the battery cell body 11. The second electrode tab 200y may be connected to another end of the electrode assembly 100. The second electrode tab 200y may be positioned at another end of the battery cell body 11.

The electrode tab 200 may form a shape protruding from the electrode assembly 100. The electrode tab 200 may form a shape protruding from the battery cell body 11. The electrode tab 200 may protrude to the outside of the pouch unit 300. For example, a portion of the electrode tab 200 may extend from the electrode assembly 100 and may be accommodated in the pouch unit 300. For example, another portion of the electrode tab 200 may extend from the portion of the electrode tab 200 and may be positioned outside the battery cell body 11.

The pouch unit 300 may include a pouch sheet 301. The pouch sheet 301 may have a sheet shape. The pouch sheet 301 may be flexible. The pouch sheet 301 may form a face

The pouch unit 300 may include a first pouch face 305. For example, the pouch sheet 301 may form the first pouch face 305. The first pouch face 305 may be a face of the pouch sheet 301. The first pouch face 305 may form an internal space of the battery cell 10 and face each other. The first pouch face 305 may face and surround the electrode assembly 100.

The pouch unit 300 may include a second pouch face 306. The second pouch face 306 may be another face of the pouch sheet 301. The second pouch face 306 may form an outer face of the battery cell 10. The second pouch face 306 may be a face positioned opposite the first pouch face 305.

The pouch sheet 301 may be molded. For example, when the pouch sheet 301 is pressed, the shape of the pouch sheet 301 may be formed. For example, a portion of the pouch unit 300 may be recessed on one face of the pouch sheet 301.

For example, the pouch unit 300 may include an accommodation portion 310. The accommodation portion 310 may accommodate the electrode assembly 100. The accommodation portion 310 may face and contact the electrode assembly 100.

The accommodation portion 310 may be concave on the first pouch face 305. The accommodation portion 310 may be convex on the second pouch face 306. In other words, the first pouch face 305 of the accommodation portion 310 may be concave, and the second pouch face 306 of the accommodation portion 310 may be convex. For another example, the accommodation portion 310 may be flat not concave.

The plurality of accommodation portions 310 may be provided. For example, two accommodation portions 310 may be provided. For example, the pouch unit 300 may include a first accommodation portion 310v and a second accommodation portion 310w.

For example, the first pouch face 305 of the first accommodation portion 310v and the first pouch face 305 of the second accommodation portion 310w may be concave, and the second pouch face 306 of the first accommodation portion 310v and the second pouch face 306 of the second accommodation portion 310w may be convex.

The pouch unit 300 may include a connection portion 315. The connection portion 315 may be positioned between the different accommodation portions 310 to connect the different accommodation portions. In other words, the connection portion 315 may be positioned between the two accommodation portions 310 to connect the two accommodation portions 310. For example, the connection portion 315 may be positioned between the first accommodation portion 310v and the second accommodation portion 310w to connect the first accommodation portion 310v and the second accommodation portion 310w.

The connection portion 315 may form one edge of the battery cell 10 (see FIG. 1). The connection portion 315 may be in close contact with the electrode assembly 100. For example, in a state where the pouch unit 300 seals the electrode assembly 100, the connection portion 315 may be in close contact with the electrode assembly 100.

The connection portion 315 may be a useful passage for discharging heat generated in the electrode assembly 100 to the outside. For example, in a state where the pouch unit 300 seals the electrode assembly 100, the connection portion 315 may be in contact with a cooling plate included in the battery module. That is, at least a portion of the heat generated in the electrode assembly 100 may be transferred to the cooling plate through the connection portion 315

After the electrode assembly 100 is accommodated in the accommodation portion 310, the pouch sheet 301 may be folded. The pouch sheet 301 may be folded at the connection portion 315. For example, in a state where the pouch unit 300 seals the electrode assembly 100, the electrode assembly 100 may be disposed and accommodated between the first accommodation portion 310v and the second accommodation portion 310w.

The battery cell body 11 may indicate a portion of the battery cell 10 in which the electrode assembly 100 is positioned. For example, the battery cell body 11 may include the accommodation portion 310 and the electrode assembly 100.

The battery cell 10 may include a battery cell edge 15. The battery cell edge 15 may form an edge of the battery cell 10. The battery cell edge 15 may be formed or positioned along a perimeter of the battery cell body 11. The battery cell edge 15 may be formed by the pouch sheet 301.

The battery cell 10 may include a battery cell edge portion 16. The battery cell edge portion 16 may be formed or positioned along the battery cell edge 15. The battery cell edge portion 16 may be positioned or formed between the battery cell edge 15 and the battery cell body 11. The battery cell edge portion 16 may be formed by the pouch sheet 301.

For example, the battery cell edge portion 16 may be formed by combining the pouch sheet 301 that is folded and faces each other. In this context, the battery cell edge portion 16 may be referred to as a “battery cell sealing portion.”

The battery cell edge 15 and the battery cell edge portion 16 may be formed on a portion of the perimeter of the battery cell body 11. For example, the battery cell edge 15 and the battery cell edge portion 16 may be formed on three edges of four edges of the battery cell body 11.

The battery cell 10 may include a close contact portion 17. The close contact portion 17 may be formed on a remaining one edge of the four edges of the battery cell body 11. The close contact portion 17 may extend in the longitudinal direction of the battery cell 10 or form an elongated surface.

The close contact portion 17 may be in close contact with the electrode assembly 100. The close contact portion 17 may be in contact with the cooling plate. At least a portion of the heat generated in the electrode assembly 100 may be transferred to the cooling plate through the close contact portion 17.

The accommodation portion 310 may include a bottom 311 and a wall 312. The wall 312 may form a perimeter of the accommodation portion 310. The wall 312 may extend from at least one of the battery cell edge portion 16 and the connection portion 315. The wall 312 may form a part of the close contact portion 17. For example, the close contact portion 17 may include the connection portion 315 and the wall 312 extending from the connection portion 315.

The bottom 311 may form the shape of a plate. For example, the bottom 311 may be entirely flat. The bottom 311 may be surrounded by the wall 312. For example, a perimeter of the bottom 311 may be connected to the wall 312. For example, the wall 312 may be bent and extended from the perimeter of the bottom 311. For example, the wall 312 may form a shape extending from the perimeter of the bottom 311 in a direction in which the first pouch face 305 faces.

The pouch sheet 301 may include a pouch sealing portion 320. For example, two pouch sealing portions 320 facing each other may be combined to each other to form the battery cell sealing portion 16. The pouch sealing portion 320 may be formed along a perimeter of the pouch sheet 301.

The battery cell sealing portion 16 may be connected to the electrode tab 200. For example, the electrode tab 200 may be positioned between the two pouch sealing portions 320 facing each other. For example, the electrode tab 200 may be in contact with the two pouch sealing portions 320 facing each other. For example, one face of the electrode tab 200 may be in contact with one of the two pouch sealing portions 320 facing each other, and another face of the electrode tab 200 may be in contact with the other of the two pouch sealing portions 320 facing each other.

The longitudinal direction of the battery cell 10 may be parallel to a direction from the first electrode tab 200x to the second electrode tab 200y. The battery cell 10, as a whole, may extend in the longitudinal direction of the battery cell 10 or form an elongated shape.

A thickness direction of the battery cell 10 may be a direction between both faces of the battery cell 10. For example, the thickness direction of the battery cell 10 may be parallel to a direction from the bottom 311 of the first accommodation portion 310v to the bottom 311 of the second accommodation portion 310w in a state where the electrode assembly 100 is sealed by the pouch unit 300.

A width direction of the battery cell 10 may be perpendicular to each of the longitudinal direction and the thickness direction of the battery cell 10. For example, the width direction of the battery cell 10 may be parallel to a direction toward the close contact portion 17 in a part of the battery cell sealing portion 16 that faces the close contact portion 17.

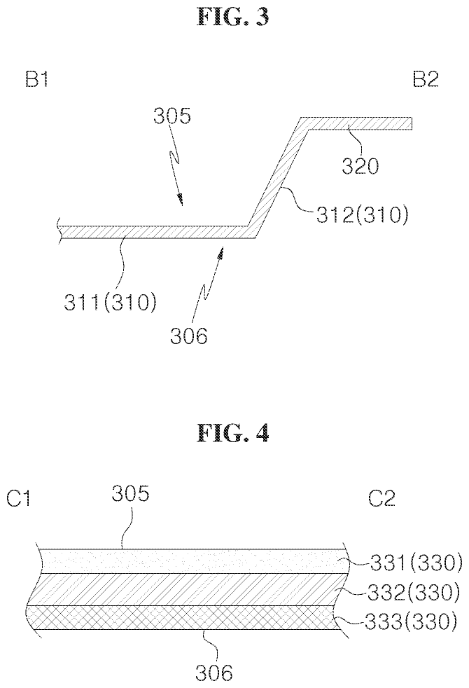

FIG. 4 is a cross-sectional view of a pouch sheet taken along C1-C2 of FIG. 2.

Referring to FIG. 4, the pouch sheet 301 may be formed by stacking a plurality of layers. For example, the pouch sheet 301 may include a layer structure 330. The layer structure 330 may be formed by sequentially stacking a plurality of layers.

The layer structure 330 may include a first layer 331. The first layer 331 may form the first pouch face 305. One face of the first layer 331 may form the first pouch face 305. In this context, the first layer 331 may be referred to as an “inner layer.”

The layer structure 330 may include a second layer 332. The second layer 332 may face other face of the first layer 331. One face of the second layer 332 may be in contact with the other face of the first layer 331.

The layer structure 330 may include a third layer 333. The third layer 333 may face other face of the second layer 332. One face of the third layer 333 may be in contact with the other face of the second layer 332. Other face of the third layer 333 may form the second pouch face 306. In this context, the third layer 333 may be referred to as an “outer layer.”

The first layer 331 may be formed of a material containing polymer. For example, the first layer 331 may include a thermally polymerizable compound. When heat is applied to the thermally polymerizable compound, polymerization or crosslinking reaction may occur in the thermally polymerizable compound. In this case, when heat is applied in a state where the two different first layers 331 contact each other, the two different first layers 331 may be bonded. When heat is applied to the first layer 331, the first layer 331 may be in a melted state, and the pair of first layers 331 may be in contact and fused with each other.

The first layer 331 may be formed of a material including at least one of polyethylene, polypropylene, polycarbonate, polyethylene terephthalate (PET), polyvinyl chloride, acrylic polymer, polyacrylonitrile, polyimide, polyamide, cellulose, aramid, nylon, polyester, polyparaphenylene benzobisoxazole (PBO), polyarylate, Teflon, or glass fiber. The first layer 331 may have a single layer structure or a multilayer structure made of two or more materials.

The second layer 332 may include a metal. For example, the second layer 332 may be formed of a material including at least one of aluminum (Al), chromium (Cr), iron (F₂), manganese (Mn), copper (Cu), stainless steel (SUS), or their alloys. The second layer 332 can achieve a good mechanical strength, moldability, and moisture blocking effect. In this context, the second layer 332 may be referred to as a “metal layer.”

The third layer 333 may protect the battery cell 10 from the outside. The third layer 333 may be formed of a film. The third layer 333 may be formed of a material including at least one of polyethylene, polypropylene, polycarbonate, polyethylene terephthalate (PET), polyvinyl chloride, acrylic polymer, polyacrylonitrile, polyimide, or polyamide. For example, the third layer 333 may be formed of a material including polyethylene terephthalate (PET).

A melting point or a fusion point of the third layer 333 may be higher than a melting point or a fusion point of the first layer 331. For example, when heat is provided to the third layer 333, the heat may pass through the second layer 332 and reach the first layer 331. In this case, the third layer 333 may not be melted, and the first layer 331 may be in a melted state.

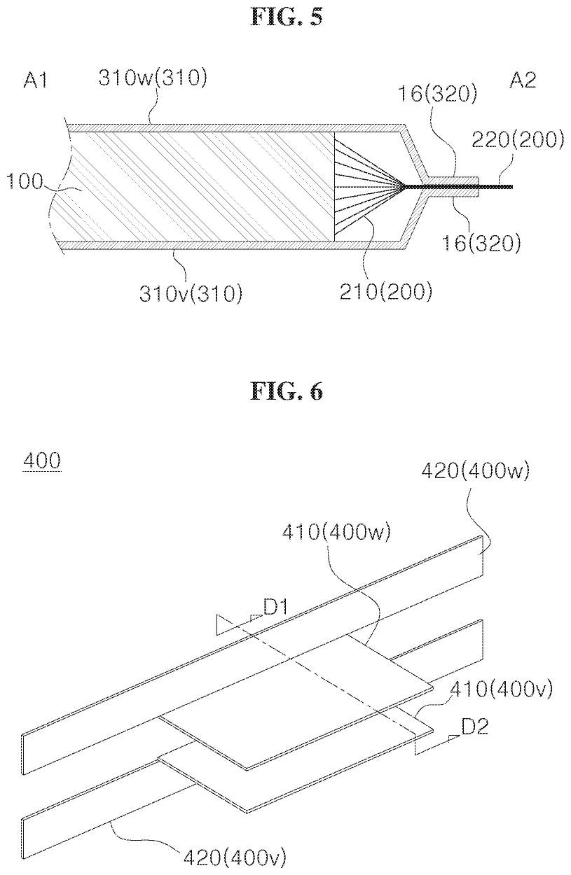

FIG. 5 is a cross-sectional view of a battery cell taken along A1-A2 of FIG. 1.

Referring to FIG. 5, a portion of the electrode tab 200 may be accommodated in the accommodation portion 310. For example, the electrode tab 200 may include an electrode foil 210. The electrode foil 210 may extend from the electrode assembly 100. A plurality of electrode foils 210 may be provided. For example, the plurality of electrode foils 210 may extend from the electrode assembly 100 toward the battery cell sealing portion.

The electrode tab 200 may include an electrode tab body 220. The electrode tab body 220 may form a shape extending from the plurality of electrode foils 210. The electrode tab body 220 may be connected to the electrode foils 210. The electrode tab body 220 may extend from the plurality of electrode foils 210 and pass through the battery cell sealing portion 16. For example, a portion of the electrode tab body 220 may be positioned outside the pouch unit 300 (see FIG. 2).

When an external force is applied to the electrode tab 200, tension may be formed in the electrode foils 210. If the tension formed in the electrode foils 210 exceeds a certain level, the electrode foils 210 may break. If at least some of the plurality of electrode foils 210 are broken, the capacity of the battery cell 10 (see FIGS. 1 and 2) may decrease. Therefore, even if the external force is applied to the electrode tab 200, there may be a need to prevent the tension from being formed in the electrode foils 210.

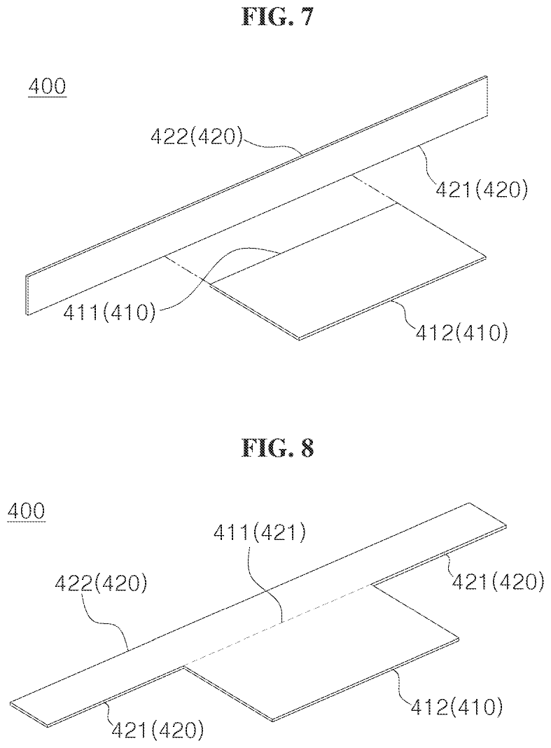

FIG. 6 is a perspective view of a guard based on an embodiment of the disclosed technology. FIG. 7 is an exploded perspective view of a guard. FIG. 8 illustrates a guard formed in one plane. A guard 400 illustrated in FIG. 8 may be bent to form a guard 400 illustrated in FIG. 6.

Referring to FIGS. 6 to 8, the battery cell 10 (see FIGS. 1 and 2) based on an embodiment of the disclosed technology may include a guard 400. The guard 400 may include a guard body 410 and a guard wing 420.

The guard body 410 may overall form the shape of a plate. The guard body 410 may include a guard body connection edge 411. The guard body connection edge 411 may be a portion of a perimeter of the guard body 410.

The guard body 410 may include a guard body extension edge 412. The guard body extension edge 412 may be another portion of the perimeter of the guard body 410. The guard body extension edge 412 may be positioned opposite the guard body connection edge 411.

The guard wing 420 may overall form the shape of a plate. The guard wing 420 may include a guard wing connection edge 421. The guard wing connection edge 421 may be a portion of a perimeter of the guard wing 420.

The guard wing 420 may include a guard wing extension edge 422. The guard wing extension edge 422 may be another portion of the perimeter of the guard wing 420. The guard wing extension edge 422 may be positioned opposite the guard wing connection edge 421.

The guard wing 420 may extend in one direction or form an elongated shape. For example, the guard wing 420 may extend in the width direction of the battery cell 10 (see FIGS. 1 and 2) or form an elongated shape.

A width of the guard wing 420 may correspond to a depth of the accommodation portion 310. The depth of the accommodation portion 310 may be a length of the accommodation portion 310 in the thickness direction of the battery cell 10. The width of the guard wing 420 may be a length of the guard wing 420 in the thickness direction of the battery cell 10.

The guard wing 420 and the guard body 410 may be connected to each other. For example, the guard body connection edge 411 of the guard body 410 may be connected to the guard wing connection edge 421 of the guard wing 420. For example, the guard body 410 may be bent at a portion of the guard wing connection edge 421 to form an extended shape.

The guard wing 420 and the guard body 410 may form an angle. For example, the guard wing 420 and the guard body 410 may form a bent shape at the guard body connection edge 411.

With reference to the width direction of the battery cell 10 (see FIGS. 1 and 2), the length of the guard wing 420 may be greater than a length of the guard body 410. For example, a length of the guard wing connection edge 421 may be greater than a length of the guard body connection edge 411.

A longitudinal direction of the guard wing 420 may be the width direction of the battery cell 10 (see FIGS. 1 and 2). A longitudinal direction of the guard body 410 may be the longitudinal direction of the guard wing 420.

The length of the guard wing 420 may be set based on the longitudinal direction of the guard wing 420. The length of the guard body 410 may be set based on the longitudinal direction of the guard wing 420.

The length of the guard wing 420 may correspond to a width direction length of the battery cell body 11 (see FIG. 1). The length of the guard body 410 may correspond to a width direction length of the electrode assembly 100 (see FIGS. 1 and 2).

For example, the length of the guard wing 420 may correspond to a width direction length of the accommodation portion 310 (see FIGS. 2 and 3). For example, the wall 312 (see FIG. 3) may prevent a width direction movement of the guard wing 420. Among the walls 312 (see FIG. 3) of the accommodation portion 310 (see FIGS. 2 and 3), the wall 312 (see FIG. 3) preventing the width direction movement of the guard wing 420 may form the close contact portion 17 (see FIG. 1) and an edge facing the close contact portion 17 (see FIG. 1). For example, the close contact portion 17 (see FIG. 1) may prevent the width direction movement of the guard wing 420.

The guard wing 420 and the guard body 410 may be formed integrally. For example, the guard wing 420 and the guard body 410 may be formed by bending one plate.

For example, when one plate is bent along the dotted line illustrated in FIG. 8, the guard body 410 and the guard wing 420 may form an angle. The dotted line illustrated in FIG. 8 may be the guard body connection edge 411. Alternatively, the dotted line illustrated in FIG. 8 may be a portion of the guard wing connection edge 421.

The plurality of guards 400 may be provided. For example, the guard 400 may include a first guard 400v and a second guard 400w. The electrode tab 200 (see FIG. 5) or the electrode tab body 220 (see FIG. 5) may be positioned between the first guard 400v and the second guard 400w.

A guard body 410 of the first guard 400v and a guard body 410 of the second guard 400w may be spaced apart from each other and face each other. The guard body 410 of the first guard 400v may be in contact with or fixed to one face of the electrode tab body 220 (see FIG. 5). The guard body 410 of the second guard 400w may be in contact with or fixed to another face of the electrode tab body 220 (see FIG. 5).

A guard wing 420 of the first guard 400v and a guard wing 420 of the second guard 400w may form shapes extending in opposite directions. For example, the guard wing 420 of the first guard 400v may form a shape extending downward from a guard body connection edge 411 of the first guard 400v, and the guard wing 420 of the second guard 400w may form a shape extending upward from a guard body connection edge 411 of the second guard 400w.

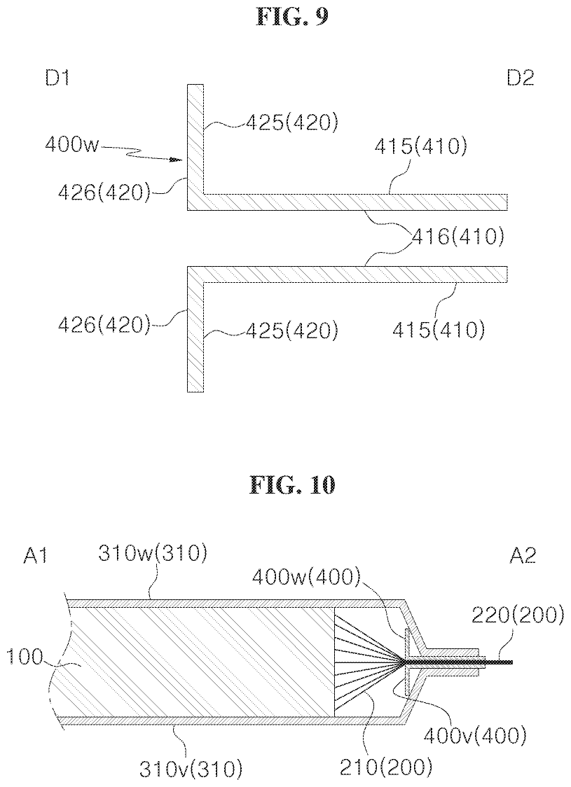

FIG. 9 is a cross-sectional view of a guard taken along D1-D2 of FIG. 6.

Referring to FIGS. 6 to 9, the guard 400 may be accommodated in the pouch unit 300 (see FIG. 2). The guard 400 may form both faces. For example, in a state in which the guard 400 is accommodated in the pouch unit 300 (see FIG. 2), one face of the guard 400 may face the pouch unit 300 (see FIG. 2), and the other face of the guard 400 may face the electrode tab 200.

For example, the guard body 410 may include a guard body outer surface 415 and a guard body inner surface 416. The guard body outer surface 415 may be a surface formed on the guard body 410 and may face or contact the pouch unit 300 (see FIG. 2). The guard body inner surface 416 may be another surface formed on the guard body 410 and may face or contact the electrode tab 200.

For example, the guard wing 420 may include a guard wing outer surface 425 and a guard wing inner surface 426. The guard wing outer surface 425 may be a surface formed on the guard wing 420 and may face or contact the pouch unit 300 (see FIG. 2). The guard wing inner surface 426 may be another surface formed on the guard wing 420 and may face or contact the electrode tab 200. The guard wing outer surface 425 may be connected to the guard body outer surface 415. The guard wing inner surface 426 may be connected to the guard body inner surface 416.

The guard outer surfaces 415 and 425 may include at least one of the guard body outer surface 415 and the guard wing outer surface 425. The guard inner surfaces 416 and 426 may include at least one of the guard body inner surface 416 and the guard wing inner surface 426.

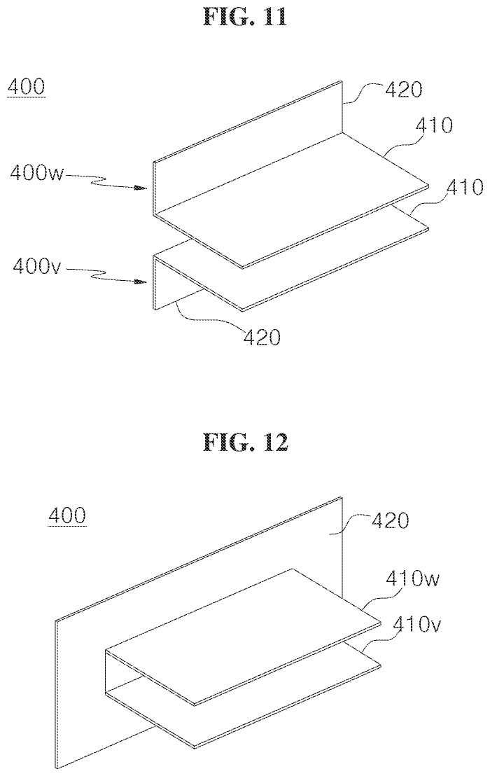

FIG. 10 is a cross-sectional view of a battery cell taken along A1-A2 of FIG. 1 when the battery cell illustrated in FIG. 1 includes the guard.

Referring to FIGS. 1 to 10, the guard 400 may be accommodated in the pouch unit 300. The guard wing 420 may be accommodated in the accommodation portion 310. For example, the guard wing 420 may be positioned between the wall 312 of the accommodation portion 310 and the electrode assembly 100.

The guard body 410 may be coupled or fixed to the electrode tab 200. For example, the guard body 410 may be coupled or fixed to the electrode tab 200 through welding. For example, the guard body inner surface 416 may be coupled or fixed to the electrode tab body 220.

The guard wing outer surface 425 may face the pouch unit 300. For example, the guard wing outer surface 425 may face the wall 312 of the accommodation portion 310. When an external force is applied to the electrode tab 200 in a direction in which the electrode tab 200 is separated from the electrode assembly 100, the wall 312 of the accommodation portion 310 may prevent the movement of the guard wing 420.

If the wall 312 of the accommodation portion 310 prevents the movement of the guard wing 420, the movement of the electrode tab 200 may be prevented. Therefore, if the wall 312 of the accommodation portion 310 prevents the movement of the guard wing 420, the tension applied to the electrode foil 210 may be limited. That is, the guard 400 can prevent the electrode foil 210 from breaking.

FIG. 11 illustrates a guard in which a length of the guard wing connection edge is the same as a length of the guard body connection edge.

Referring to FIG. 11, the length of the guard body connection edge 411 (see FIG. 7) of the guard body 410 may be the same as the length of the guard wing connection edge 421 (see FIG. 7) of the guard wing 420.

The guard 400 illustrated in FIG. 11 may be formed of a rectangular metal plate. The guard 400 illustrated in FIG. 11 may be formed by preparing two rectangular metal plates and bending each of the two rectangular metal plates. Therefore, the guard 400 illustrated in FIG. 11 can be relatively better in terms of process efficiency and cost, compared to the guard 400 illustrated in FIG. 6.

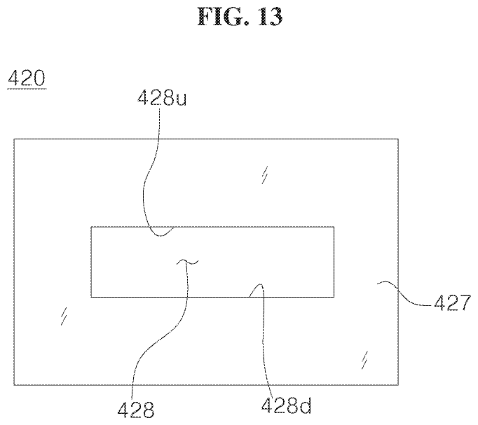

FIG. 12 illustrates a guard in which a guard wing of a first guard and a guard wing of a second guard are connected to form one body. FIG. 13 illustrates a guard wing illustrated in FIG. 12.

Referring to FIGS. 12 and 13, the guard wing 420 of the first guard 400v (see FIG. 6) and the guard wing 420 of the second guard 400w (see FIG. 6) may be connected to form one body. In other words, the guard 400 may include a first guard body 410v, a second guard body 410w, and the guard wing 420.

The guard wing 420 may include a guard wing plate 427. The guard wing plate 427 may be a plate forming both faces. For example, the guard wing plate 427 may form the guard wing outer surface 425 (see FIG. 9) and the guard wing inner surface 426 (see FIG. 9).

The guard wing 420 may include a guard wing opening 428. The guard wing opening 428 may be an opening formed in the guard wing plate 427. The guard wing opening 428 may form a plurality of edges.

For example, the guard wing opening 428 may include a first guard wing opening edge 428d. The first guard wing opening edge 428d may be a portion of the edge formed in the guard wing opening 428.

The first guard wing opening edge 428d may be connected to the first guard body 410v. For example, the first guard body 410v may form a shape extending from the first guard wing opening edge 428d.

For example, the guard wing opening 428 may include a second guard wing opening edge 428u. The second guard wing opening edge 428u may be another portion of the edge formed in the guard wing opening 428. The second guard wing opening edge 428u may be positioned opposite the first guard wing opening edge 428d.

The second guard wing opening edge 428u may be connected to the second guard body 410w. For example, the second guard body 410w may form a shape extending from the second guard wing opening edge 428u.

A distance between the first guard body 410v and the second guard body 410w may correspond to a distance between the first guard wing opening edge 428d and the second guard wing opening edge 428u. The first guard body 410v, the second guard body 410w, and the guard wing 420 may be formed integrally.

The electrode tab body 220 (see FIG. 5) may be inserted and coupled between the first guard body 410v and the second guard body 410w. The guard wing plate 427 illustrated in FIGS. 12 and 13 can more effectively prevent the movement of the electrode tab 200 (see FIGS. 2 and 5).

The first guard body 410v, the second guard body 410w, and the guard wing 420 may be formed integrally. For example, the guard 400 may be formed of one plate.

For example, a cut line may be formed in an area corresponding to the guard wing opening 428 in one plate, and the one plate may be cut along the cut line. Thereafter, the cut plate may bend along the first guard wing opening edge 428d to form the first guard body 410v, and may bend along the second guard wing opening edge 428w to form the second guard body 410w.

The one plate forming the guard 400 may be formed of a material containing metal. Since the guard 400 is formed by cutting and bending the one plate, the durability of the guard 400 can be relatively good.

Referring to FIGS. 1 to 13, the first electrode tab 200x and the second electrode tab 200y may be positioned opposite to each other. For another example, the first electrode tab 200x and the second electrode tab 200y may be positioned side by side. For example, the first electrode tab 200x and the second electrode tab 200y may be positioned side by side at one edge of the battery cell body 11.

When the first electrode tab 200x and the second electrode tab 200y are positioned side by side at one edge of the battery cell body 11, it can be seen that the first electrode tab 200x and the second electrode tab 200y are disposed left and right.

Even if the first electrode tab 200x and the second electrode tab 200y are positioned side by side at one edge of the battery cell body 11, the guard 400 may be coupled to the electrode tab 200. The guard 400 coupled to the first electrode tab 200x may be referred to as a “left guard”, and the guard 400 coupled to the second electrode tab 200y may be referred to as a “right guard.”

A guard wing 420 of the left guard 400 may be coupled or connected to a guard wing 420 of the right guard 400. For example, a guard wing 420 of a first guard 400v of the left guard 400 may be connected to a guard wing 420 of a first guard 400v of the right guard 400. For example, a guard wing 420 of a second guard 400w of the left guard 400 may be connected to a guard wing 420 of a second guard 400w of the right guard 400.

Some embodiments or other embodiments of the disclosed technology described above are not mutually exclusive or distinct from each other. Configurations or functions of some embodiments or other embodiments of the disclosed technology described above can be used together or combined with each other. Only specific examples of implementations of certain embodiments are described. Variations, improvements and enhancements of the disclosed embodiments and other embodiments may be made based on the disclosure of this patent document.

What is claimed is:

1. A battery cell comprising:
an electrode assembly;
a pouch unit being sealed, the pouch unit including:
a pouch sheet configured to form an inner face and an outer face; and
an accommodation portion formed on the inner face of the pouch sheet, the accommodation portion accommodating the electrode assembly, the accommodation portion being concave on the inner face of the pouch sheet;
an electrode tab configured to extend from the electrode assembly, pass through the pouch unit, and protrude from the pouch unit; and
a guard including:
a guard body coupled to the electrode tab; and
a guard wing configured to bend and extend from the guard body and be accommodated in the accommodation portion.

2. The battery cell of claim 1, wherein the pouch unit further includes a pouch sealing portion that is formed along a perimeter of the pouch sheet and is connected to the accommodation portion,
wherein the accommodation portion includes:
a wall connected to the pouch sealing portion; and
a bottom configured to bend and extend from the wall,
wherein the wall extends from a perimeter of the bottom.

3. The battery cell of claim 2, wherein the guard wing faces the wall.

4. The battery cell of claim 2, wherein the electrode tab includes:
a plurality of electrode foils configured to extend from the electrode assembly toward the guard body; and
an electrode tab body configured to extend from the plurality of electrode foils and coupled to the guard body.

5. The battery cell of claim 4, wherein the guard wing is positioned between the wall and the plurality of electrode foils.

6. The battery cell of claim 4, wherein the guard wing includes:
a guard wing outer surface configured to face the wall; and
a guard wing inner surface configured to face the plurality of electrode foils.

7. The battery cell of claim 1, wherein, a length of the guard wing is greater than a length of the guard body, with reference to a width direction of the battery cell.

8. The battery cell of claim 1, wherein, when the electrode tab moves in a direction in which the electrode tab is separated from the electrode assembly, the accommodation portion prevents a movement of the guard wing.

9. The battery cell of claim 1, wherein, a length of the guard wing corresponds to a length of the accommodation portion, with reference to a thickness of the battery cell.

10. The battery cell of claim 1, wherein the guard wing and the guard body are formed integrally.

11. The battery cell of claim 1, wherein the accommodation portion includes a first accommodation portion and a second accommodation portion that are formed on the inner face of the pouch sheet and are spaced apart from each other, the first accommodation and the second accommodation being concave on the inner face of the pouch sheet, and
wherein the pouch unit further includes a connection portion positioned between the first accommodation portion and the second accommodation portion, the connection portion connecting the first accommodation portion and the second accommodation portion.

12. The battery cell of claim 11, wherein the guard includes:
a first guard, at least a part of the first guard being accommodated in the first accommodation portion; and
a second guard, at least a part of the second guard being accommodated in the second accommodation portion.

13. The battery cell of claim 12, wherein each of the first guard and the second guard includes the guard body and the guard wing, and
wherein the guard body of the first guard and the guard body of the second guard are spaced apart from each other and face each other.

14. The battery cell of claim 13, wherein a direction in which the guard wing of the first guard extends from the guard body of the first guard is opposite to a direction in which the guard wing of the second guard extends from the guard body of the second guard.

15. The battery cell of claim 1, wherein, a length of the guard wing is a length of the guard body, with reference with a width direction of the battery cell.

16. The battery cell of claim 1, wherein the guard wing includes:
a guard wing plate configured to form both faces; and
a guard wing opening formed in the guard wing plate.

17. The battery cell of claim 16, wherein the guard wing plate includes:
a guard wing inner surface configured to face the electrode assembly; and
a guard wing outer surface formed opposite the guard wing inner surface.

18. The battery cell of claim 16, wherein the guard body includes:
a first guard body extending from a side of the guard wing opening; and
a second guard body extending from another side of the guard wing opening.

19. The battery cell of claim 18, wherein the electrode tab is positioned between the first guard body and the second guard body.

20. The battery cell of claim 18, wherein the first guard body and the second guard body are spaced apart from each other and face each other.
